(19) United States
(12) Patent Application Publication
(10) Pub. No.: US 2024/0413490 A1
(43) Pub. Date: Dec. 12, 2024

(54) SECONDARY BATTERY

(71) Applicant: KABUSHIKI KAISHA TOSHIBA, Tokyo (JP)

(72) Inventors: Naoki IWAMURA, Yokohama Kanagawa (JP); Kuniaki YAMAMOTO, Yokohama Kanagawa (JP)

(73) Assignee: KABUSHIKI KAISHA TOSHIBA, Tokyo (JP)

(21) Appl. No.: 18/804,225

(22) Filed: Aug. 14, 2024

Related U.S. Application Data
(63) Continuation of application No. PCT/JP2022/006634, filed on Feb. 18, 2022.

(51) Int. Cl. H01M 50/533; H01M 10/0587; H01M 50/103; H01M 50/15; H01M 50/342; H01M 50/474; H01M 50/534; H01M 50/55

(52) U.S. Cl. CPC H01M 50/533; H01M 10/0587; H01M 50/103; H01M 50/15; H01M 50/3425; H01M 50/474; H01M 50/534; H01M 50/55

(57) ABSTRACT

According to one embodiment, at least one of a positive electrode lead and a negative electrode lead of a secondary battery is formed of a metal plate and includes a first joint portion arranged facing a lid and joined to an output terminal, a second joint portion arranged facing an inner surface of one of long side walls and joined to one of a positive electrode current-collecting tab and a negative electrode current-collecting tab, and a first extending portion extending from one end portion of the first joint portion along the other long side wall toward a center portion of the long side wall in a longitudinal direction and arranged facing the center portion in the longitudinal direction at an inner surface of the other long side wall.

### CROSS-REFERENCE TO RELATED APPLICATIONS

This application is a Continuation application of PCT Application No. PCT/JP2022/006634, filed Feb. 18, 2022, the entire contents of which are incorporated herein by reference.

### FIELD

Embodiments described herein relate generally to a secondary battery.

### BACKGROUND

In recent years, secondary batteries with high energy density, e.g., lithium-ion secondary batteries, have been widely used as power sources for electronic devices and electric vehicles. Such secondary batteries are configured by housing an electrode body having a positive electrode and a negative electrode and a nonaqueous electrolyte in a rectangular-shaped outer container made of aluminum or aluminum alloy. A positive output terminal and a negative output terminal are provided on the lid of the outer container. The positive and negative output terminals are connected to the positive and negative electrodes of the electrode body via positive and negative electrode leads provided in the outer container, respectively.

In a manufacturing process of a secondary battery, an electrolyte is poured into the outer container through an inlet port on the lid, and then the inlet port is sealed in a state where the inside of the outer container is depressurized.

In recent years, as secondary batteries have become larger in capacity and current, their outer containers have also become larger in size. Therefore, when the pressure inside the outer container is reduced, the outer container may be significantly deformed.

### BRIEF DESCRIPTION OF THE DRAWINGS

FIG. 1 is a perspective view showing the appearance of a secondary battery according to a first embodiment.

FIG. 2 is an exploded perspective view of the secondary battery.

FIG. 3 is a perspective view showing a negative electrode lead.

FIG. 4 is a perspective view of the negative electrode lead as viewed from a back surface side.

FIG. 5 is a perspective view showing a positive electrode lead.

FIG. 6 is a perspective view of the secondary battery with an outer container omitted.

FIG. 7 is a front view of the secondary battery with an outer container omitted.

FIG. 8 is a cross-sectional view of the secondary battery taken along line A-A in FIG. 1.

FIG. 9 is a cross-sectional view of the secondary battery taken along line B-B in FIG. 1.

FIG. 10 is a perspective view showing a secondary battery according to a second embodiment with an outer container omitted.

FIG. 11 is a cross-sectional view of the secondary battery according to the second embodiment, corresponding to FIG. 8.

FIG. 12 is a cross-sectional view of the secondary battery according to the second embodiment, corresponding to FIG. 9.

FIG. 13 is a perspective view showing a secondary battery according to a third embodiment with an outer container omitted.

FIG. 14 is a cross-sectional view of the secondary battery according to the third embodiment, corresponding to FIG. 8.

FIG. 15 is a cross-sectional view of the secondary battery according to the third embodiment, corresponding to FIG. 9.

### DETAILED DESCRIPTION

Various embodiments will be described hereinafter with reference to the accompanying drawings. In general, according to one embodiment, a secondary battery comprises an outer container having a pair of long side walls facing each other at a distance and a lid fixed to one end of the pair of long side walls; an electrode body stored in the outer container and including a group of electrodes and a positive electrode current-collecting tab and a negative electrode current-collecting tab extending from the group of electrodes; a pair of output terminals provided on the lid; a positive electrode lead provided between the electrode body and the lid in the outer container and electrically connecting one of the output terminals and the positive electrode current-collecting tab; and a negative electrode lead provided between the electrode body and the lid in the outer container and electrically connecting the other output terminal and the negative electrode current-collecting tab. At least one of the positive electrode lead and the negative electrode lead is formed of a metal plate and includes a first joint portion arranged facing the lid and joined to the output terminal, a second joint portion arranged facing an inner surface of one of the long side walls and joined to one of the positive electrode current-collecting tab and the negative electrode current-collecting tab, and a first extending portion extending from one end portion of the first joint portion along the other long side wall toward a center portion of the long side wall in a longitudinal direction and arranged facing the center portion in the longitudinal direction at an inner surface of the other long side wall.

The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. Further, in the specification and drawings, corresponding elements are denoted by like reference numerals, and a detailed description thereof may be omitted unless otherwise necessary.

### First Embodiment

A secondary battery according to a first embodiment is described in detail.

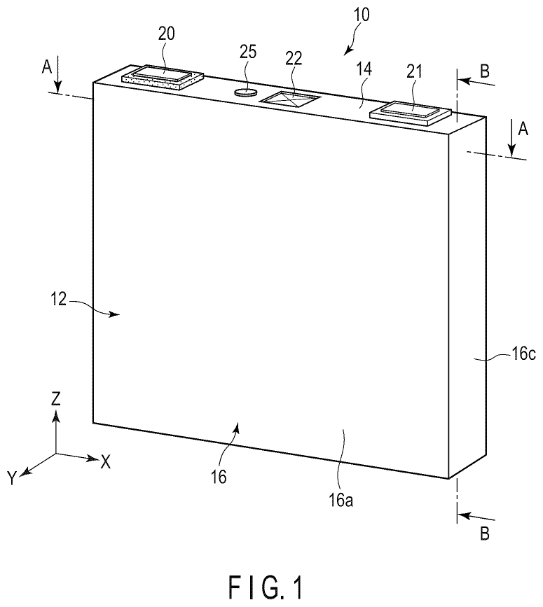

FIG. 1 is a perspective view showing the appearance of the secondary battery according to the first embodiment.

As shown in the drawing, a secondary battery 10 is a nonaqueous electrolyte secondary battery, such as a lithium ion battery. The secondary battery 10 comprises an outer container 12 of an approximately flat rectangular shape, and an electrode body 30 described below, which is stored in the outer container 12 with a nonaqueous electrolyte. The outer container 12 is, for example, an outer can (battery case) made of a metal plate such as aluminum, aluminum alloy, iron, or stainless steel.

The outer container 12 includes a container body 16 with an open top end and a rectangular plate-shaped lid 14 welded to the container body 16 and closing the opening of the container body 16, forming an airtight interior. The lid 14 is provided with a positive electrode terminal 20 and a negative electrode terminal 21 as a pair of output terminals, a pressure relief valve (safety valve) 22, and an inlet port. The inlet port is sealed by a disk-shaped sealing lid 25.

Here, a longitudinal direction of the lid 14 and the container body 16 is defined as X, a width direction of the lid 14 and the container body 16 orthogonal to the longitudinal direction X as Y, and a height direction of the container body 16 as Z.

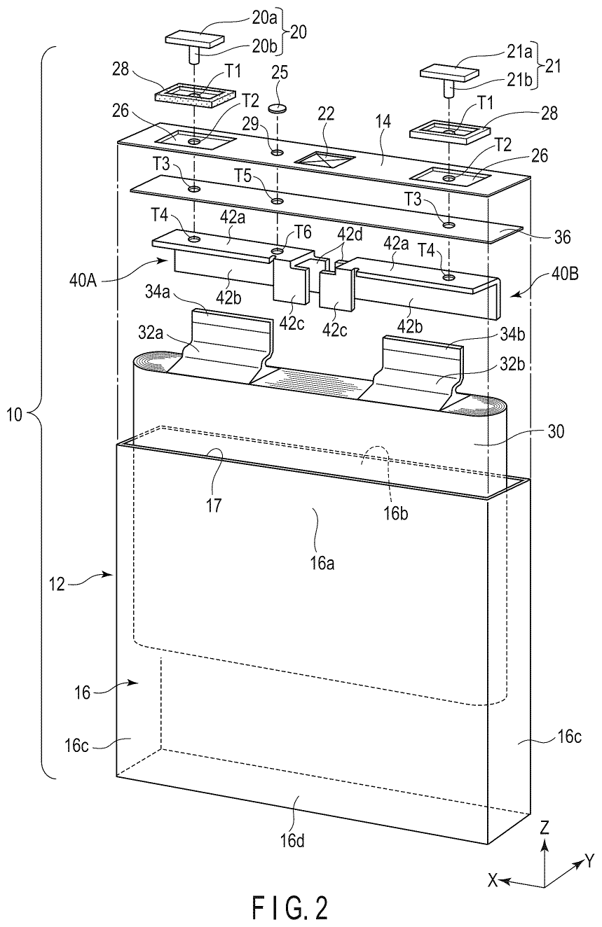

FIG. 2 is an exploded perspective view of the secondary battery.

As shown in the drawing, the container body 16 of the outer container 12 has a rectangular long side wall 16a, a rectangular long side wall 16b that faces the long side wall 16a in parallel at a distance from the long side wall 16a, a pair of short side walls 16c facing each other, and a bottom wall 16d. A rectangular upper opening 17 is defined by upper edges of the pair of long side walls 16a and 16b and upper edges of the pair of short side walls 16c.

The lid 14 is formed as a rectangular plate substantially equal in size to the upper opening 17. The lid 14 is fixed to the container body 16 with its outer circumferential edge welded to an upper edge portion of the container body 16, closing the upper opening 17.

Rectangular recesses 26 are formed at each end portion of the lid 14 in the longitudinal direction X, and a sealing material, e.g., a gasket 28, made of synthetic resin, glass, or other insulating material is attached to each of the recesses 26. Through holes T1 and T2 are formed in the center portion of each of the gaskets 28 and recesses 26.

The positive electrode terminal 20 integrally comprises a substantially rectangular terminal body 20a and a connecting rod 20b extending downward from the bottom surface of the terminal body 20a. The positive electrode terminal 20 is mounted on the gasket 28 with the connecting rod 20b inserted through the through holes T1 and T2 of the gasket 28 and the recess 26. Similarly, the negative electrode terminal 21 integrally comprises a substantially rectangular terminal body 21a and a connecting rod 21b extending downward from the bottom of the terminal body 21a. The negative electrode terminal 21 is mounted on the gasket 28 with the connecting rod 21b inserted through the through holes T1 and T2 of the gasket 28 and recess 26.

The lid 14 has a safety valve (pressure relief valve) 22, which functions as a gas venting mechanism, and a nonaqueous electrolyte inlet port 29 formed thereon. The safety valve 22 is formed in the center of the longitudinal direction X of the lid 14 and is provided between the positive electrode terminal 20 and the negative electrode terminal 21. The safety valve 22 is formed by making a part of the area of the lid 14 approximately half the thickness of the other areas. When gas is generated in the outer container 12 due to an abnormal mode of the secondary battery 10, etc., and the internal pressure of the outer container 12 rises to or above a predetermined value, the safety valve 22 is opened to reduce the internal pressure and prevent the outer container 12 from problems such as bursting.

The inlet port 29 is formed on the lid 14 between the positive electrode terminal 20 and the safety valve 22. After pouring the nonaqueous electrolyte into the outer container 12 through the inlet port 29, the inlet port 29 is sealed with the disk-shaped sealing lid 25, for example.

As shown in FIG. 2, the electrode body 30 stored in the outer container 12 includes a group of electrodes formed in a flat rectangular shape, for example. The group of electrodes is formed by spirally winding a sheet-shaped positive electrode plate and negative electrode plate with a separator between them and further compressing them in a radial direction. The positive electrode plate includes a band-shaped positive electrode current collector, a positive electrode active material layer formed on at least one surface of the current collector, and a strip-shaped positive electrode current-collecting tab 32a extending in the short side direction from a plurality of locations on the long side of the positive electrode current collector. The negative electrode plate has a shape similar to that of the positive electrode plate, and includes a band-shaped negative electrode current collector, a negative electrode active material layer formed on at least one surface of the negative electrode current collector, and a strip-shaped negative electrode current-collecting tab 32b extending in the short side direction from a plurality of locations on the long side of the negative electrode current collector. The spirally wound electrode body (electrode group) 30 is fixed by a winding tape, not shown.

The current collectors and the current-collecting tabs of the positive and negative electrode plates are formed, in one example, from a metal foil of approximately 5 to 50 μm thickness. The material of the metal foil can be aluminum, aluminum alloy, copper, or copper alloy, for example, although it can vary depending on the type of active material used for the positive and negative electrodes.

A plurality of positive electrode current-collecting tabs 32a extend outward from one end of the electrode body (electrode group) 30 in the winding axial direction and are stacked on each other in the thickness direction of the electrode body 30. The extended end portions of the plurality of positive electrode current-collecting tabs 32a are held together by a U-shaped bent backup lead 34a. The positive electrode current-collecting tabs 32a are located at one end side of the electrode body 30 in the longitudinal direction X.

A plurality of negative electrode current-collecting tabs 32b extend outward from one end of the electrode body 30 in the winding axial direction and in the same direction as the positive electrode current-collecting tabs 32a, and are stacked on each other in the thickness direction of the electrode body 30. The extended end portions of the plurality of negative electrode current-collecting tabs 32b are held together by a U-shaped bent backup lead 34b. The negative electrode current-collecting tabs 32b are located at the other end side of the electrode body 30 in the longitudinal direction X.

Thus, the positive electrode current-collecting tabs 32a and the negative electrode current-collecting tabs 32b extend from one end of the electrode body 30 in the same direction and are located apart from each other in the longitudinal direction X of the electrode body 30.

The electrode body 30 configured as described above is stored within the container body 16 with its winding axis coinciding with the height direction Z of the outer container 12 and with one end face of the electrode body 30, the positive electrode current-collecting tabs 32a, and the negative electrode current-collecting tabs 32b oriented toward the side of the lid 14. One end face of the electrode body 30 faces the lid 14 at a predetermined distance.

As shown in FIG. 2, the secondary battery 10 comprises within the outer container 12 an insulator 36, a positive electrode lead 40A, and a negative electrode lead 40B provided in the space between the electrode body 30 and the lid 14. The insulator 36 is formed in the shape of a rectangular plate with approximately the same dimensions as the lid 14. The insulator 36 is arranged facing the inner surface of the lid 14. The insulator 36 has a pair of through holes T3 facing the pair of through holes T2 of the lid 14, respectively, and a through hole T5 facing the inlet port 29.

The positive electrode lead 40A is arranged between the insulator 36 and the positive electrode current-collecting tab 32a, and electrically connects the positive electrode terminal 20 and the positive electrode current-collecting tab 32a. The negative electrode lead 40B is arranged between the insulator 36 and the negative electrode current-collecting tab 32b, and electrically connects the negative electrode terminal 21 and the negative electrode current-collecting tab 32b.

The positive electrode lead 40A and the negative electrode lead 40B are described in detail below.

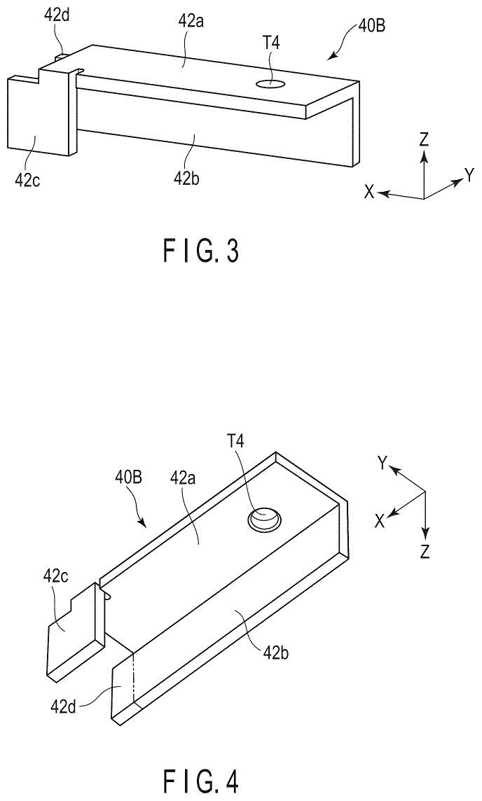

FIG. 3 is a perspective view of the negative electrode lead, FIG. 4 is a perspective view of the negative electrode lead observed from the bottom surface side, and FIG. 5 is a perspective view of the positive electrode lead.

As shown in FIG. 2, FIG. 3, and FIG. 4, the negative electrode lead 40B is configured by bending a conductive metal sheet material, for example, at right angles to form an L-shaped cross section. In one example, the negative electrode lead 40B includes a rectangular first joint portion 42a, and a rectangular second joint portion 42b located along one long side of the first joint portion 42a and extending substantially perpendicular to the first joint portion 42a.

The first joint portion 42a has a length slightly shorter than half the length of the lid 14 in the longitudinal direction X and a width slightly shorter than the width of the lid 14 in the width direction Y. The first joint portion 42a is arranged so that a pair of long sides extend in the longitudinal direction X and face the lid 14 in parallel. The first joint portion 42a is provided with a through hole T4 for joining the connecting rod 21b of the negative electrode terminal 21. Furthermore, the first joint portion 42a integrally includes a first extending portion 42c provided at one end portion of the other long side (a long side facing the long side continuous with the second joint portion 42b). The first extending portion 42c is substantially rectangular and extends along the long side wall 16a of the container body 16 in the height direction Z from the first joint portion 42a and beyond one end of the first joint portion 42a in the longitudinal direction X, toward the side of the center portion of the lid 14 in the longitudinal direction X. The width of the first extending portion 42c in the height direction Z is formed to be substantially the same as the width of the second joint portion 42b described below, and the length of the first extending portion in the longitudinal direction X is formed substantially the same as the width of the first joint portion 42a.

The second joint portion 42b has the same length as the first joint portion 42a in the longitudinal direction X and a width slightly smaller than the width of the first joint portion 42a in the height direction Z. The second joint portion 42b extends from one end to the other end of one long side of the first joint portion 42a. The second joint portion 42b has a pair of long sides extending in the longitudinal direction X and is located facing the long side wall 16b of the container body 16 with an insulating member described below interposed therebetween. The second joint portion 42b integrally includes a second extending portion 42d extending from one end in the longitudinal direction X beyond one end of the first joint portion 42a and toward the center of the long side wall 16b in the longitudinal direction X. The second extending portion 42d has a rectangular shape and is formed with the same width as the width of the second joint portion 42b in the height direction z and with an extending length in the longitudinal direction X that is substantially equal to the width of the second extending portion 42d. The second extending portion 42d faces the first extending portion 42c in parallel at a distance corresponding to the width of the first joint portion 42a. That is, the first extending portion 42c faces only the portion of the second extending portion 42d of the second joint portion 42b. The inner surface of the second joint portion 42b forms a joining surface not facing the first extending portion 42c.

As shown in FIG. 2 and FIG. 5, the positive electrode lead 40A is formed symmetrical to the negative electrode lead 40B, with the same configuration and dimensions. In detail, the positive electrode lead 40A is configured by bending a conductive metal sheet material, for example, at right angles to form an L-shaped cross section. The positive electrode lead 40A includes a rectangular first joint portion 42a, and a rectangular second joint portion 42b located along one long side of the first joint portion 42a and substantially perpendicular to the first joint portion 42a. The first joint portion 42a integrally includes a first extending portion 42c provided at one end portion of the other long side. The first extending portion 42c is substantially rectangular and extends from the first joint portion 42a along the long side wall 16a of the container body 16 in the height direction Z and beyond one end of the first joint portion 42a in the longitudinal direction X, toward the side of the center portion of the long side wall 16a in the longitudinal direction X.

The second joint portion 42b integrally includes a second extending portion 42d extending from one end in the longitudinal direction X beyond one end of the first joint portion 42a in the longitudinal direction X and toward the side of the center portion of the lid 14 in the longitudinal direction X. The second extending portion 42d faces the first extending portion in parallel at a distance corresponding to the width of the first joint portion 42a. That is, the first extending portion faces only the two extending portions of the second joint portion 42b.

In the positive electrode lead 40A, the first joint portion 42a is provided with a through hole T6 facing the inlet port 29 in addition to a through hole T4 for joining the connecting rod 20b of the positive electrode terminal 20.

The positive electrode lead 40A and the negative electrode lead 40B configured as described above are arranged between the lid 14 and the electrode body 30 in the outer container 12, and are connected to the output terminals and the current-collecting tabs, respectively.

An internal configuration of the assembled secondary battery 10 is described below.

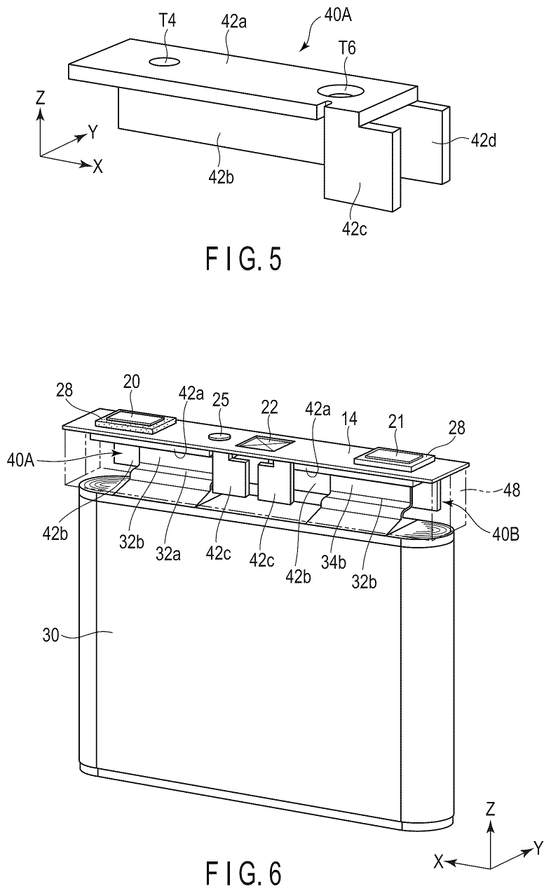

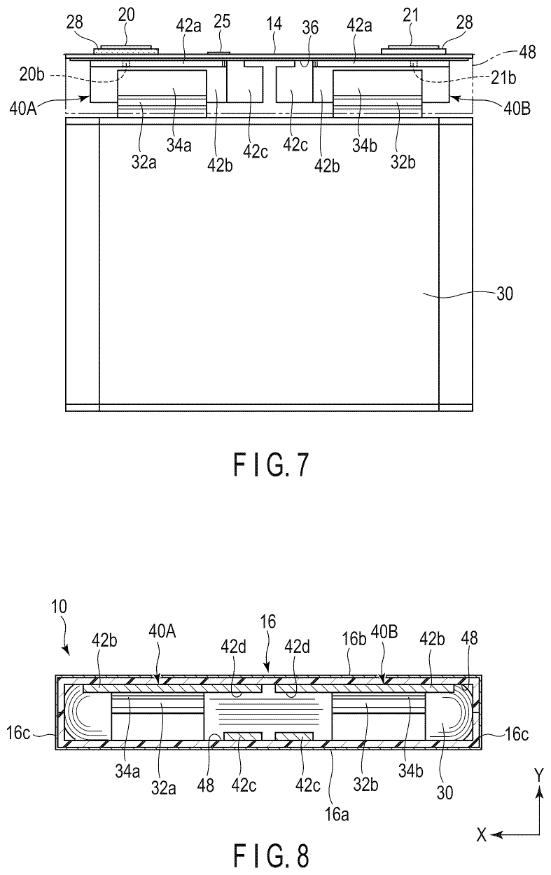

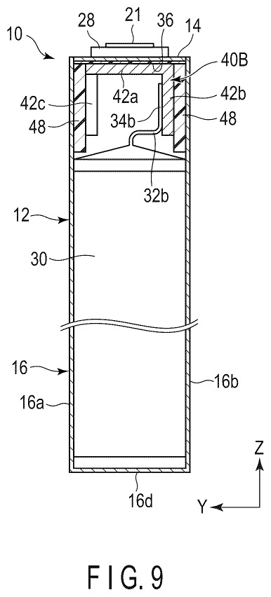

FIG. 6 is a perspective view of the secondary battery with the outer container omitted, FIG. 7 is a front view of the secondary battery with the outer container omitted, FIG. 8 is a cross-sectional view of the secondary battery along line A-A in FIG. 1, and FIG. 9 is a cross-sectional view of the secondary battery along line B-B in FIG. 1.

As shown in FIG. 6 and FIG. 7, the connecting rod 20b of the positive electrode terminal 20 is fitted into the through hole T4 of the first joint portion 42a of the positive terminal lead 40A through the through hole T1 of the gasket 28, the through hole T2 of the lid 14, and the through hole T3 of the insulator 36, and joined to the first joint portion 42a by laser welding, ultrasonic bonding, etc. As a result, the positive electrode terminal 20 is fixed to the outer surface of the lid 14 through the gasket 28 and is also electrically connected to the positive electrode lead 40A. The first joint portion 42a faces parallel to the inner surface of the lid 14 across the insulator 36 and extends in the longitudinal direction X from near the end of the positive electrode terminal 20 side of the lid 14 to near the center portion of the lid 14 in the longitudinal direction X. The through hole T6 of the first joint portion 42a is aligned with the through hole T5 of the insulator 36 and the inlet port 29 of the lid 14. The lid 14 and the positive electrode lead 40A are electrically insulated by the insulator 36.

The second joint portion 42b extends substantially perpendicular to the first joint portion 42a and the lid 14 and is located on one long side of the first joint portion 42a and on one long side of the lid 14. The second extending portion 42d of the second joint portion 42b is located adjacent the center portion of the long side wall 16b in the longitudinal direction X. The positive electrode current-collecting tab 32a and the backup lead 34a are joined to the inner surface (joining surface) of the second joint portion 42b and electrically connected to the positive electrode lead 40A. For example, laser welding, ultrasonic bonding, resistance welding, and other methods are used for joining.

On the other hand, the first extending portion 42c is located on the other long side of the first joint portion 42a and the other long side of the lid 14, and extends substantially perpendicular to the first extending portion 42c. Furthermore, the first extending portion 42c is located adjacent to the center portion of the lid 14 in the longitudinal direction X.

The connecting rod 21b of the negative electrode terminal 21 is fitted into the through hole T4 of the first joint portion 42a of the negative electrode lead 40B through the through hole T1 of the gasket 28, the through hole T2 of the lid 14, and the through hole T3 of the insulator 36, and is joined to the first joint portion 42a by ultrasonic bonding or the like. As a result, the negative electrode terminal 21 is fixed to the outer surface of the lid 14 via the gasket 28 and is also electrically connected to the negative electrode lead 40B. The first joint portion 42a faces parallel to the inner surface of the lid 14 across the insulator 36 and extends in the longitudinal direction X from near the end of the negative electrode terminal 21 side of the lid 14 to near the center portion of the lid 14 in the longitudinal direction X. The lid 14 and the negative electrode lead 40B are electrically insulated by the insulator 36.

The second joint portion 42b extends substantially perpendicular to the first joint portion 42a and the lid 14 and is located on one long side of the first joint portion 42a and on one long side of the lid 14. The second extending portion 42d of the second joint portion 42b is located adjacent the center portion of the lid 14 in the longitudinal direction X. The negative electrode current-collecting tab 32b and the backup lead 34b are joined to the inner surface of the second joint portion 42b and electrically connected to the negative electrode lead 40b. For example, laser welding, ultrasonic bonding, resistance welding, and other methods are used for joining.

On the other hand, the first extending portion 42c is located on the other long side of the first joint portion 42a and the other long side of the lid 14, and extends substantially perpendicular to the first extending portion 42c. Furthermore, the first extending portion 42c is located adjacent to the center portion of the lid 14 in the longitudinal direction X.

Within the outer container 12, a rectangular frame-shaped insulating member 48 is provided between the electrode body 30 and the lid 14, surrounding the positive electrode lead 40A and the negative electrode lead 40B.

As shown in FIG. 8 and FIG. 9, the insulating member 48 is formed from an insulating material such as synthetic resin in the form of a sheet or plate having a predetermined thickness. In one example, the insulating member 48 is affixed to the inner surface of the container body 16 and covers an area between the end of the upper opening side of the container body 16 and the end face of the electrode body 30 over an entire circumference.

The second joint portion 42b and the second extending portion 42d of the positive electrode lead 40A abut substantially parallel to the inner surface of the long side wall 16b of the container body 16 with the insulating member 48 interposed therebetween. The second extending portion 42d faces the center portion of the long side wall 16b in the longitudinal direction X. The first extending portion 42c of the positive electrode lead 40A abuts substantially parallel to the inner surface of the long side wall 16a on the opposite side with the insulating member 48 interposed therebetween. The first extending portion 42c faces the center portion of the long side wall 16a in the longitudinal direction X.

The second joint portion 42b and the second extending portion 42d of the negative electrode lead 40b abut substantially parallel to the inner surface of the long side wall 16b of the container body 16 with the insulating member 48 interposed therebetween. The second extending portion 42d faces the center portion of the long side wall 16b in the longitudinal direction X. The second extending portion 42d also faces the second extending portion 42d of the positive electrode lead 40A with a gap in the longitudinal direction X. The first extending portion 42c of the negative electrode lead 40B abuts substantially parallel to the inner surface of the long side wall 16a on the opposite side with the insulating member 48 interposed therebetween. The first extending portion 42c faces the center portion of the long side wall 16a in the longitudinal direction X. The first extending portion 42c also faces the first extending portion 42c of the positive electrode lead 40A with a gap in the longitudinal direction X.

The positive electrode lead 40A and the negative electrode lead 40B are electrically insulated from the container body 16 by the insulating member 48.

In manufacturing the secondary battery 10 configured as described above, after the nonaqueous electrolyte is injected into the outer container 12 through the inlet port 29, the pressure inside the outer container 12 is reduced, and in this reduced pressure state, the inlet port 29 is sealed with the sealing lid 25. In a secondary battery, when pressure is reduced, the center portions of the long side walls 16a and 16b of the container body 16 in the longitudinal direction X may deform inward. In a case where the length of the long side walls in the longitudinal direction X is lengthened as the size and capacity of the battery increases, the outer container is likely to deform more easily.

In contrast, according to the secondary battery 10 of the present embodiment, the positive electrode lead 40A and the negative electrode lead 40B include the first extending portion 42c and the second extending portion 42d facing the center portion of the long side walls 16a and 16b in the longitudinal direction X, respectively. The first extending portion 42c and the second extending portion 42d press the center portion of the long side walls 16a and 16b from the inside, thereby suppressing deformation of the long side walls 16a and 16b. At the same time, the deformation of the safety valve 22 provided near the center portion of the long side walls 16a and 16b can be suppressed, preventing unintentional opening of the safety valve and ensuring a normal operation thereof.

The first extending portion 42c is provided at a size and location such that it faces only the second extending portion 42d of the second joint portion 42b. That is, the positive electrode lead 40A and the negative electrode lead 40B do not have a plate portion facing the entire second joint portion 42b. Therefore, the volume of the positive electrode lead 40A and the negative electrode lead 40B is smaller than that of the electrode leads including a plate portion facing the entire second joint portion 42B, and the volume of the space between the electrode body 30 and the lid 14 in the outer container 12 is larger by that amount. By increasing the size of the above space that accommodates gases generated in the event of an abnormality, it is possible to reduce the risk of secondary battery outbursts.

Furthermore, since there is no plate portion facing the second joint portion 42b and the joining surface of the second joint portion 42b is open, the work of joining the current-collecting tabs to the joining surface of the second joint portion 42b can be easily performed. This makes it possible to improve the assembly and productivity of the secondary battery.

In summary, according to the first embodiment, it is possible to provide a secondary battery in which deformation of the outer container can be suppressed.

Next, a secondary battery according to other embodiments of the present invention will be described. In the other embodiments described below, the same parts and components as those in the first embodiment described above will be given the same reference symbols as those in the first embodiment, and their descriptions will be omitted or simplified, and the description will focus on the parts that differ from the first embodiment.

### Second Embodiment

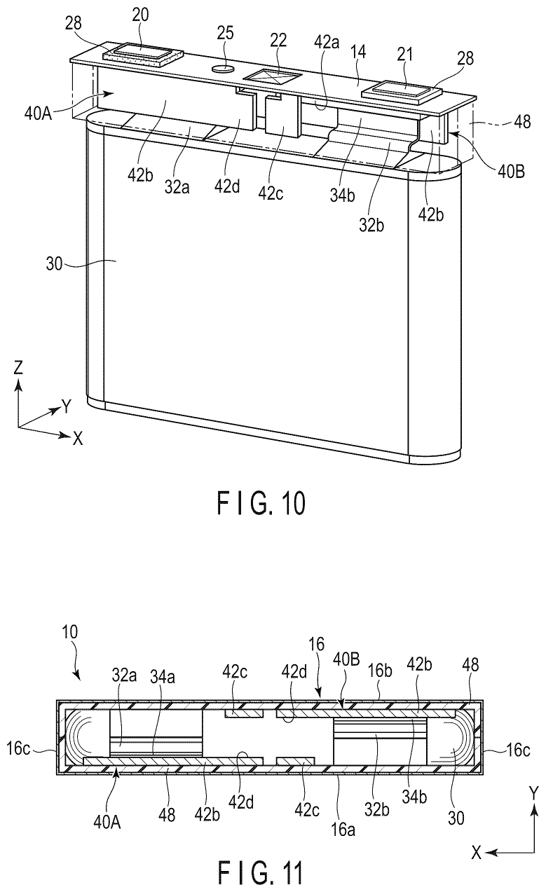

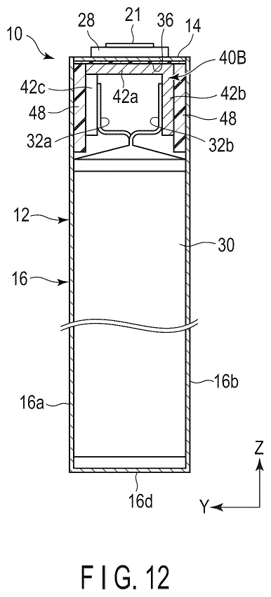

FIG. 10 is a perspective view of a secondary battery of a second embodiment with the container body omitted, FIG. 11 is a cross-sectional view of the secondary battery of the second embodiment, corresponding to FIG. 8, and FIG. 12 is a cross-sectional view of the secondary battery of the second embodiment, corresponding to FIG. 9.

In the first embodiment described above, two types of electrode leads with symmetrical shapes are used as the positive and negative electrode leads. In contrast, the second embodiment uses one type of electrode lead of the same shape and dimensions as the positive and negative electrode leads.

As shown in the drawing, according to the second embodiment, a positive electrode lead 40A and a negative electrode lead 40B are formed in the same configuration, shape, and dimensions as, for example, the negative electrode lead 40B in the first embodiment. That is, each of the positive electrode lead 40A and the negative electrode lead 40B integrally includes a rectangular plate-shaped first joint portion 42a, a rectangular plate-shaped second joint portion 42b orthogonal to the first joint portion 42a, a first extending portion 42c extending in a height direction Z and a longitudinal direction X from one end portion of one long side of the first joint portion 42a, and a second extending portion 42d extending in the longitudinal direction X beyond the first joint portion 42a from one end of the second joint portion 42b. However, in the second embodiment, the first joint portion 42a is provided with a through hole for connecting a connecting rod of an output terminal and a through hole that can face an inlet port of a lid 14.

One electrode lead, e.g., the negative electrode lead 40B, is arranged in the same orientation as the negative electrode lead 40B in the first embodiment described above. The first joint portion 42a of the negative electrode lead 40B faces parallel to the inner surface of the lid 14 and extends from an end portion on the side of a negative electrode terminal 21 to near the center portion in the longitudinal direction X. The first joint portion 42a is electrically connected to the negative electrode terminal 21. At the center portion in the longitudinal direction X, the first extending portion 42c of the first joint portion 42a abuts the inner surface of a long side wall 16a of a container body 16 with an insulating member 48 interposed therebetween. The second joint portion 42b abuts the inner surface of a long side wall 16b of the container body 16 with the insulating member 48 interposed therebetween. The second extending portion 42d of the second joint portion 42b abuts the inner surface of the long side wall 16b at the center portion in the longitudinal direction X with the insulating member 48 interposed therebetween. A negative electrode current-collecting tab 32b and a backup lead 34b of an electrode body 30 are joined to the inner surface (joining surface) of the second joint portion 42b and electrically connected to the negative electrode lead 40B.

The other electrode lead, here the positive electrode lead 40A, is arranged in an orientation inverted by 180 degrees with respect to the negative electrode lead 40B. The first joint portion 42a of the positive electrode lead 40A faces parallel to the inner surface of the lid 14 and extends from an end portion on the side of a positive electrode terminal 20 to near a center portion in the longitudinal direction X. The first joint portion 42a is electrically connected to the positive electrode terminal 20. At the center portion in the longitudinal direction X, the first extending portion 42c of the first joint portion 42a abuts the inner surface of the long side wall 16b of the container body 16 with the insulating member 48 interposed therebetween. The first extending portion 42c faces the second extending portion 42d of the negative electrode lead 40B with a gap in the longitudinal direction X.

The second joint portion 42b of the positive electrode lead 40A abuts the inner surface of the long side wall 16a of the container body 16 with the insulating member 48 interposed therebetween. The second extending portion 42d of the second joint portion 42b abuts the inner surface of the long side wall 16a at the center portion in the longitudinal direction X, with the insulating member 48 interposed therebetween. A positive electrode current-collecting tab 32a and a backup lead 34a of the electrode body 30 are welded to the inner surface of the second joint portion 42b and electrically connected to the positive electrode lead 40A.

In the second embodiment, the other configurations of the secondary battery 10 is identical to those of the secondary battery 10 of the first embodiment.

The secondary battery 10 according to the second embodiment configured as described above also has the same effect as the secondary battery according to the first embodiment. In addition, according to the second embodiment, by making the positive and negative electrode leads common electrode leads, the number of parts of the secondary battery can be reduced and the manufacturing cost can be lowered.

Note that, in the second embodiment, the positive electrode lead 40A and the negative electrode lead 40B may be formed with the same configuration, shape, and dimensions as the positive electrode lead 40A in the first embodiment. In this case, the positive electrode lead 40A is arranged in the same orientation as the positive electrode lead 40A in the first embodiment, and the negative electrode lead 40B is arranged in an orientation inverted by 180 degrees.

### Third Embodiment

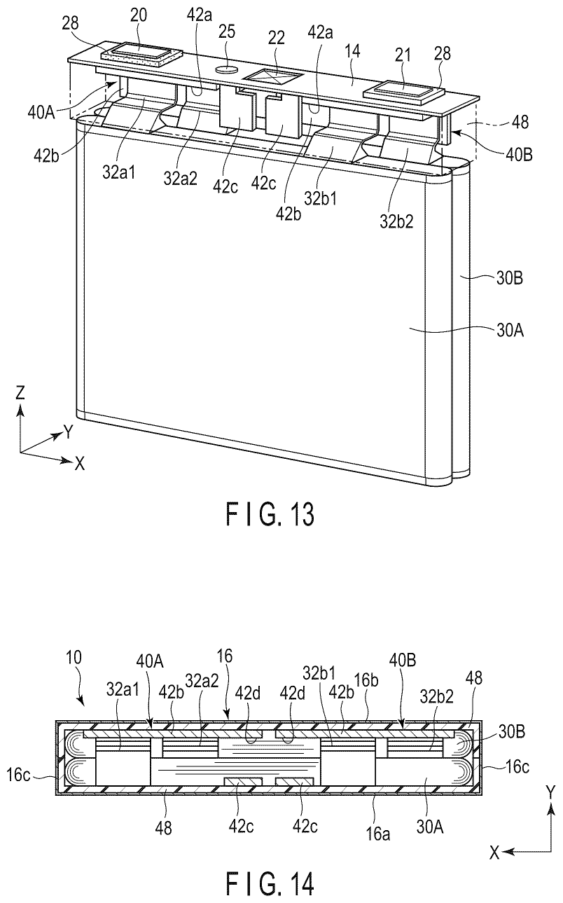

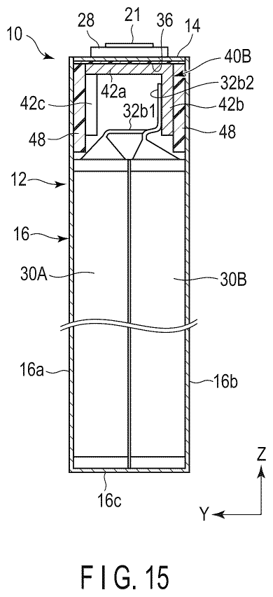

FIG. 13 is a perspective view of a secondary battery according to a third embodiment with a container body omitted, FIG. 14 is a cross-sectional view of the secondary battery according to the third embodiment, corresponding to FIG. 8; and FIG. 15 is a cross-sectional view of the secondary battery according to the third embodiment, corresponding to FIG. 9.

As shown in the drawings, a secondary battery 10 according to the third embodiment comprises a plurality of electrode bodies, e.g., two electrode bodies 30A and 30B, which are stored in an outer container 12.

The electrode body 30A is configured in the same manner as the electrode body 30 in the first embodiment described above. However, the electrode body 30A is formed more flatly than the electrode body 30 and has a thickness of approximately ½ of the thickness of the electrode body 30 in a width direction Y. The electrode body 30A includes a group of electrodes and a positive electrode current-collecting tab 32a1 and a negative electrode current-collecting tab 32b1 extending from the electrode group in a height direction Z. The positive electrode current-collecting tab 32a1is located at one end side of the electrode body 30A in a longitudinal direction X. The negative electrode current-collecting tab 32b1 is located at the other end side of the electrode body 30A in the longitudinal direction X. Thus, the positive electrode current-collecting tab 32a1and the negative electrode current-collecting tab 32b1 extend in the same direction from one end of the electrode body 30A and are located apart from each other in the longitudinal direction X of the electrode body 30A.

The electrode body 30A configured as described above is stored within a container body 16 with a winding axis coinciding with the height direction Z of an outer container 12 and with the positive electrode current-collecting tab 32a1and the negative electrode current-collecting tab 32b1 oriented toward the side of a lid 14. One end face of the electrode body 30A faces the lid 14 at a distance.

The electrode body 30B is configured in the same manner as the electrode body 30A. The electrode body 30B includes a group of electrodes and a positive electrode current-collecting tab 32a2 and a negative electrode current-collecting tab 32b2 extending from the electrode group in the height direction Z. The positive electrode current-collecting tab 32a2 is located at one end side of the electrode body 30B in the longitudinal direction X. The negative electrode current-collecting tab 32b2 is located at the other end side of the electrode body 30A in the longitudinal direction X. The positive electrode current-collecting tab 32a2 and the negative electrode current-collecting tab 32b2 extend in the same direction from one end of the electrode body 30B and are located apart from each other in the longitudinal direction X of the electrode body 30A. The positive electrode current-collecting tab 32a2 and the negative electrode current-collecting tab 32b2 are located at positions displaced in the longitudinal direction X relative to the positive electrode current-collecting tab 32a1and the negative electrode current-collecting tab 32b1 of the electrode body 30A, respectively.

The electrode body 30B configured as described above is stored in the container body 16 with a winding axis coinciding with the height direction z of the outer container 12 and with the positive electrode current-collecting tab 32a2 and the negative electrode current-collecting tab 32b2 oriented toward the side of the lid 14, and is arranged side by side with the electrode body 30A in the width direction Y.

The positive electrode current-collecting tab 32a1of the electrode body 30A and the positive electrode current-collecting tab 32a2 of the electrode body 30B are located misaligned with each other in the longitudinal direction X, without overlapping in the width direction Y. The positive electrode current-collecting tab 32a1and the positive electrode current-collecting tab 32a2 are joined to a second joint portion 42b of a positive electrode lead 40A and electrically connected to the positive electrode lead 40A. The negative electrode current-collecting tab 32b1 of the electrode body 30A and the negative electrode current-collecting tab 32b2 of the electrode body 30B are located misaligned with each other in the longitudinal direction X, without overlapping in the width direction Y. The negative electrode current-collecting tab 32b1 and the negative electrode current-collecting tab 32b2 are joined to the second joint portion 42b of the negative electrode lead 40B and electrically connected to the negative electrode lead 40B.

In the third embodiment, the other configurations of the secondary battery 10 are identical to those of the secondary battery 10 of the first embodiment.

The secondary battery 10 according to the third embodiment configured as described above also has the same effect as the secondary battery according to the first embodiment. In addition, according to the third embodiment, by providing a plurality of electrode bodies, it is possible to increase the capacity of the secondary battery.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the aforementioned embodiments, the positive and negative electrode leads have the same configuration, i.e., both leads are configured to include a first extending portion and a second extending portion; however, it is not limited thereto, and at least one electrode lead may be configured to include a first extending portion. In such a configuration, deformation of the outer container can be suppressed by the first extending portion of one electrode lead.

The electrode body is not limited to a so-called wound type electrode body in which an electrode plate is wound, but a so-called laminated type electrode body in which a plurality of electrode plates are laminated in the thickness direction may also be applied. The electrode body is not limited to a so-called vertical type electrode body in which a positive electrode current-collecting tab and a negative electrode current-collecting tab extend in the same direction, but a so-called horizontal type electrode body in which the positive electrode current-collecting tab and the negative electrode current-collecting tab extend in opposite directions may be applied.

The materials, shapes, sizes, and the like of the elements configuring the secondary battery are not limited to those in the above-described embodiment, and can be modified in various ways as necessary.

What is claimed is:

1. A secondary battery comprising:
an outer container having a pair of long side walls facing each other at a distance and a lid fixed to one end of the pair of long side walls;
an electrode body stored in the outer container and including a group of electrodes and a positive electrode current-collecting tab and a negative electrode current-collecting tab extending from the group of electrodes;
a pair of output terminals provided on the lid;
a positive electrode lead provided between the electrode body and the lid in the outer container and electrically connecting one of the output terminals and the positive electrode current-collecting tab; and
a negative electrode lead provided between the electrode body and the lid in the outer container and electrically connecting the other output terminal and the negative electrode current-collecting tab, wherein
at least one of the positive electrode lead and the negative electrode lead is formed of a metal plate and includes a first joint portion arranged facing the lid and joined to the output terminal, a second joint portion arranged facing an inner surface of one of the long side walls and joined to one of the positive electrode current-collecting tab and the negative electrode current-collecting tab, and a first extending portion extending from one end portion of the first joint portion along the other long side wall toward a center portion of the long side wall in a longitudinal direction and arranged facing the center portion in the longitudinal direction at an inner surface of the other long side wall.

2. The secondary battery of claim 1, wherein
the second joint portion integrally includes a second extending portion extending from one end of the second joint portion along the one long side wall toward the center portion of the long side wall in the longitudinal direction and facing the center portion in the longitudinal direction at an inner surface of the one long side wall, and
the first extending portion faces only the portion of the second extending portion of the second joint portion.

3. The secondary battery of claim 2, wherein
the second joint portion has a joining surface that does not face the first extending portion, and
one of the positive electrode current-collecting tab and the negative electrode current-collecting tab is joined to the joining surface.

4. The secondary battery of claim 1, further comprising an insulating member provided between the long side wall and the first extending portion, wherein
the first extending portion abuts the inner surface of the long side wall with the insulating member interposed therebetween.

5. The secondary battery of claim 2, further comprising an insulating member provided between the long side wall and the second joint portion, wherein
the second joint portion and the second extending portion abut the inner surface of the long side wall with the insulating member interposed therebetween.

6. The secondary battery of claim 5, wherein the positive electrode lead and the negative electrode lead each have the same configuration as the at least one lead and are symmetrically shaped with respect to each other.

7. The secondary battery of claim 5, wherein the positive electrode lead and the negative electrode lead each have the same configuration and the same shape as the at least one lead, and wherein one of the positive electrode lead and the negative electrode lead is arranged in an inverted orientation with respect to the other lead.

8. The secondary battery of claim 5, wherein the outer container includes a pressure relief valve formed in a center portion of the lid in the longitudinal direction.

9. The secondary battery of claim 1, wherein
the electrode body includes a first electrode body including an electrode group and a positive electrode current-collecting tab and a negative electrode current-collecting tab extending from the electrode group and stored in the outer container, and a second electrode body including an electrode group and a positive electrode current-collecting tab and a negative electrode current-collecting tab extending from the electrode group and stored in the outer container alongside the first electrode body,
the positive electrode current-collecting tab of the first electrode body and the positive electrode current-collecting tab of the second electrode body are arranged side by side in the longitudinal direction and joined to the positive electrode lead, and
the negative electrode current-collecting tab of the first electrode body and the negative electrode current-collecting tab of the second electrode body are arranged side by side in the longitudinal direction and joined to the negative electrode lead.

10. The secondary battery of claim 1, wherein the positive electrode lead and the negative electrode lead each have the same configuration as the at least one lead and are symmetrically shaped with respect to each other.

11. The secondary battery of claim 1, wherein the positive electrode lead and the negative electrode lead each have the same configuration and the same shape as the at least one lead, and wherein one of the positive electrode lead and the negative electrode lead is arranged in an inverted orientation with respect to the other lead.

12. The secondary battery of claim 1, wherein the outer container includes a pressure relief valve formed in a center portion of the lid in the longitudinal direction.
